(19) United States
(12) Patent Application Publication
(10) Pub. No.: US 2006/0214574 A1
(43) Pub. Date: Sep. 28, 2006

(54) Light emitting element and method for manufacturing the same

(75) Inventors: Masao Kawaguchi, Osaka (JP); Hiroshi Ohno, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/384,246

(22) Filed: Mar. 21, 2006

(30) Foreign Application Priority Data
Mar. 25, 2005 (JP) 2005-088368

(51) Int. Cl. H01J 1/62; H01J 63/04

(52) U.S. Cl. 313/506

(57) ABSTRACT

A light emitting element including: a semiconductor layer stack including a light emitting layer; a metal optical reflection film which is formed on the surface of the semiconductor layer stack opposite to the surface from which light emitted from the light emitting layer is taken out of the semiconductor layer stack to reflect the emitted light; a metal cover film which is formed above the metal optical reflection film to prevent the metal optical reflection film from coming off; and a metal anti-diffusion film which is formed between the metal optical reflection film and the metal cover film to prevent interdiffusion between the metal optical reflection film and the metal cover film. The metal anti-diffusion film is a single layer film made of any one of tungsten, rhenium and tantalum or a layered film made of two or more of tungsten, rhenium and tantalum.

### CROSS-REFERENCE TO RELATED APPLICATION

This non-provisional application claims priority under 35 U.S.C. §119(a) of Japanese Patent Application No. 2005-088368 filed in Japan on Mar. 25, 2005, the entire contents of which are hereby incorporated by reference.

### BACKGROUND OF THE INVENTION

1. Field of the Invention

The present invention relates to a light emitting element which works with high luminance and high efficiency and a method for manufacturing the same.

2. Description of Related Art

In recent years, attention has been paid to semiconductor light emitting elements such as light emitting diodes because of their small sizes and high luminous efficiency. As light generated by a light emitting layer in the light emitting element is radiated in various directions, only part of the light is taken out of the light exit side of the light emitting element for use. Therefore, in order to improve the luminance, it is getting more important to take out light which is radiated in other directions than the direction toward the light exit side.

For example, according to Japanese Unexamined Patent Publication No. H11-191641, an electrode of the light emitting element is made of silver (Ag) or aluminum (Al) having high reflectivity in a wide wavelength region ranging from ultraviolet to infrared. Part of light which is emitted from the light emitting layer in the direction opposite to the light exit side of the light emitting element is reflected on the electrode toward the light exit side, thereby improving the luminance of the light emitting element. However, the electrode made of Ag or Al does not have as high adhesion property as a conventional electrode made of gold (Au). Therefore, the Ag or Al electrode is likely to come off during the step of wire bonding or the step of bonding a different substrate thereto. Then, in order to prevent the electrode from coming off, Japanese Unexamined Patent Publication No. H11-186598 discloses an electrode including a reflection film made of Ag or Al and a metal cover film which is made of Au and formed on the reflection film.

In the case of using Ag or Al as the electrode, it is required to reduce contact resistance thereof to a sufficient degree by heat treatment. Even if the reflectivity of the electrode improves, a high contact resistance of the electrode decreases the luminous efficiency, thereby decreasing the luminance of the light emitting element. Further, as Au and Ag or Al are likely to cause interdiffusion, Au and Ag or Al are mixed through the heat treatment to bring about a decrease in reflectivity of the electrode.

### SUMMARY OF THE INVENTION

In light of the above-described problem of the conventional light emitting element, an object of the present invention is to achieve a high-luminance light emitting element including an electrode having low contact resistance and high reflectivity and a method for manufacturing the same.

In order to achieve the object, according to the present invention, an electrode of the light emitting element includes a metal anti-diffusion film between a metal optical reflection film and a metal cover film to prevent interdiffusion between them.

Specifically, the light emitting element of the present invention includes: a semiconductor layer stack including a light emitting layer; a metal optical reflection film which is formed on the surface of the semiconductor layer stack opposite to the surface from which light emitted from the light emitting layer is taken out of the semiconductor layer stack to reflect the emitted light; a metal cover film which is formed above the metal optical reflection film to prevent the metal optical reflection film from coming off; and a metal anti-diffusion film which is formed between the metal optical reflection film and the metal cover film to prevent interdiffusion between the metal optical reflection film and the metal cover film, wherein the metal anti-diffusion film is a single layer film made of any one of tungsten, rhenium and tantalum or a layered film made of two or more of tungsten, rhenium and tantalum.

As to the light emitting element of the present invention, the metal optical reflection film and the metal cover film hardly cause interdiffusion therebetween even when heat treatment is carried out to form ohmic contact between the electrode and the semiconductor layer. Therefore, the reflectivity of the metal optical reflection film is kept high and the light emitting element is provided with high luminance.

The thickness of the metal anti-diffusion film of the light emitting element of the present invention is preferably 50 nm or more. According to this structure, the interdiffusion between the metal optical reflection film and the metal cover film is surely prevented.

The metal optical reflection film of the light emitting element of the present invention is preferably a single layer film made of aluminum or silver or a layered film made of aluminum and silver. According to this structure, the metal optical reflection film reflects the emitted light with efficiency.

In this case, the thickness of the metal optical reflection film is preferably 80 nm or more. According to this structure, the interdiffusion between the metal optical reflection film and the metal cover film is prevented.

The metal cover film of the light emitting element of the present invention is preferably made of gold, platinum or an alloy containing at least one of gold and platinum. According to this structure, wire bonding or connection to a different substrate is carried out with reliability.

It is preferable that the light emitting element of the present invention further includes a metal contact resistance reducing film which is formed between the metal optical reflection film and the semiconductor layer stack to reduce contact resistance between the metal optical reflection film and the semiconductor layer stack. According to this structure, the contact resistance of the electrode is further reduced, thereby improving the luminous efficiency of the light emitting element.

The metal contact resistance reducing film of the light emitting element of the present invention is preferably a single layer film made of any one of nickel, titanium, gold, platinum, palladium and rhodium or a layered film made of two or more of nickel, titanium, gold, platinum, palladium and rhodium. According to this structure, the contact resistance is surely reduced.

The semiconductor layer stack of the light emitting element of the present invention is preferably made of a group III nitride semiconductor.

A method for manufacturing a light emitting element according to the present invention includes the steps of: forming a first conductivity type semiconductor layer, a light emitting layer and a second conductivity type semiconductor layer in this order on a first substrate to provide a semiconductor layer stack; forming a metal optical reflection film for reflecting light emitted from the light emitting layer, a metal anti-diffusion film which is a single layer film made of any one of tantalum, rhenium and tungsten or a layered film made of two or more of tantalum, rhenium and tungsten and a metal cover film for preventing the metal optical reflection film from coming off in this order on the second conductivity type semiconductor layer to provide an electrode; and heat-treating the electrode.

According to the method of the present invention, the interdiffusion between the metal optical reflection film and the metal cover film is prevented from occurring in the heat treatment. Therefore, the reflectivity of the metal optical reflection film is kept high, thereby providing the light emitting element with high luminance.

According to the method of the present invention, the thickness of the metal anti-diffusion film is preferably 50 nm or more. According to this structure, the interdiffusion between the metal optical reflection film and the metal cover film is surely prevented.

According to the method of the present invention, the semiconductor layer stack is preferably made of a group III nitride semiconductor and the heat treatment is carried out at a temperature ranging from 500° C. or higher to 600° C. or lower. According to this structure, the contact resistance of the electrode is surely reduced.

According to the method of the present invention, the metal optical reflection film is preferably a single layer film made of aluminum or silver or a layered film made of aluminum and silver. In this case, the thickness of the metal optical reflection film is preferably 80 nm or more. According to this structure, the emitted light is reflected by the metal optical reflection film with efficiency.

According to the method of the present invention, the metal cover film is preferably made of gold, platinum or an alloy containing at least one of gold and platinum. According to this structure, wire bonding or connection to a different substrate is carried out with reliability.

It is preferable that the method of the present invention further includes the step of forming a metal contact resistance reducing film between the metal optical reflection film and the second conductivity type semiconductor layer to reduce contact resistance between the metal optical reflection film and the second conductivity type semiconductor layer. In this case, the metal contact resistance reducing film is preferably a single layer film made of any one of nickel, titanium, gold, platinum, palladium and rhodium or a layered film made of two or more of nickel, titanium, gold, platinum, palladium and rhodium. According to this structure, the contact resistance of the electrode is further reduced, the luminous efficiency improves and heat generation in the element is reduced.

It is preferable that the method of the present invention further includes the steps of: bonding a second conductive substrate to the metal cover film; and peeling the first substrate off before the bonding step. According to this structure, the light emitting element is provided with a light exit side at the top side thereof.

### BRIEF DESCRIPTION OF THE DRAWINGS

FIG. 1 is a sectional view illustrating a light emitting element according to a first embodiment of the present invention.

FIGS. 2A to 2D are sectional views illustrating the steps of manufacturing the light emitting element according to the first embodiment of the present invention.

FIG. 3 is a graph illustrating a relationship between the contact resistance of an electrode used in the light emitting element of the first embodiment and temperature for heat-treating the electrode.

FIG. 4 is a graph illustrating a relationship between the melting point of a metal anti-diffusion film used in the light emitting element of the first embodiment and reflectivity.

FIG. 5 is a graph illustrating composition distribution in a heat-treated conventional electrode including a stack of gold and silver.

FIG. 6 is a graph illustrating composition distribution in a heat-treated electrode including a metal anti-diffusion film used in the light emitting element of the first embodiment.

FIG. 7 is a graph illustrating a relationship between the wavelength of light entering the electrode including the metal anti-diffusion film used in the light emitting element of the first embodiment and reflectivity.

FIG. 8 is a sectional view illustrating a light emitting element as a variant of the first embodiment of the present invention.

FIG. 9 is a graph illustrating a relationship between the thickness of a metal contact resistance reducing film used in the light emitting element as the variant of the first embodiment and reflectivity.

FIG. 10 is a sectional view illustrating a light emitting element according to a second embodiment of the present invention.

FIGS. 11A to 11C are sectional views illustrating the steps of manufacturing the light emitting element according to the second embodiment of the present invention.

FIGS. 12A and 12B are sectional views illustrating the steps of manufacturing the light emitting element according to the second embodiment of the present invention.

### DETAILED DESCRIPTION OF THE INVENTION

### First Embodiment

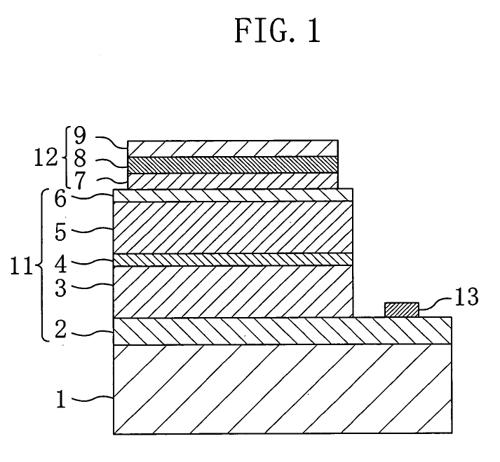

Referring to the drawings, an explanation of a light emitting element and a method for manufacturing the same according to the first embodiment of the present invention will be provided. FIG. 1 is a sectional view illustrating the structure of the light emitting element of the first embodiment. As shown in FIG. 1, the light emitting element of the present embodiment is a blue light emitting diode using gallium nitride (GaN)-based material.

An n-type contact layer 2 made of n-type GaN is formed on a sapphire substrate 1. On the n-type contact layer 2, an n-type cladding layer 3 made of n-type aluminum gallium nitride (Al_{0.1}Gao_{0.9}N) is formed with part of the n-type contact layer 2 left exposed. Further, a light emitting layer 4, a p-type cladding layer 5 made of p-type Al_{0.3}Ga_{0.7}N and a p-type contact layer 6 made of p-type GaN are formed thereon in this order. These layers form a semiconductor layer stack 11. The light emitting layer 4 is made of InGaN layers and GaN layers which are stacked alternately to have a multiple quantum-well structure.

On the p-type contact layer 6, a 150 nm thick metal optical reflection film 7 made of silver (Ag), a 100 nm thick metal anti-diffusion film 8 made of tungsten (W) and a 150 nm thick metal cover film 9 made of gold (Au) are stacked in this order to provide a p-type electrode 12.

On the exposed part of the n-type contact layer 2, a 5 nm thick titanium (Ti) layer, a 40 nm thick aluminum (Al) layer, a 40 nm thick nickel (Ni) layer and a 200 nm thick gold (Au) layer are stacked in this order to provide an n-type electrode 13.

The p-type electrode 12 and the n-type electrode 13 of the light emitting element of the first embodiment may be bonded to different substrates, respectively, or electric wiring may be achieved in the light emitting element by bonding such that the light emitting element functions as a flip-chip light emitting diode which takes the light out in the direction toward the substrate 1. Part of the light emitted from the light emitting layer 4 toward the p-type electrode 12 is reflected on the metal optical reflection film 7 toward the substrate 1. Therefore, the emitted light is efficiently used.

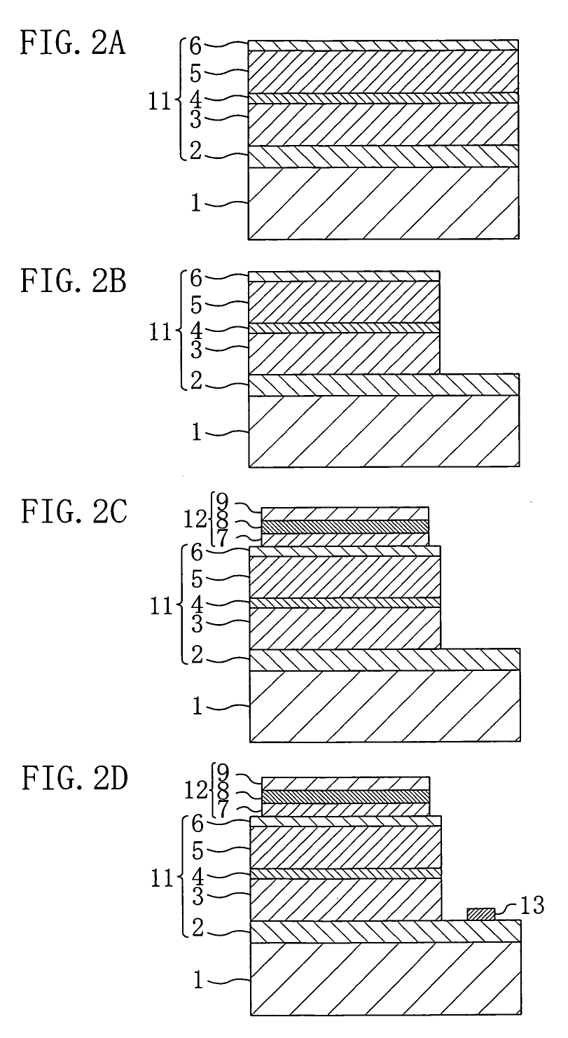

Hereinafter, an explanation of a method for manufacturing the light emitting element of the first embodiment will be provided with reference to the drawings. FIGS. 2A to 2D are sectional views illustrating the steps of manufacturing the light emitting element of the present embodiment. As shown in FIG. 2A, first, an n-type contact layer 2, an n-type cladding layer 3, a light emitting layer 4, a p-type cladding layer 5 and a p-type contact layer 6 are grown in this order on a sapphire substrate 1 by metal-organic chemical vapor deposition (MOCVD).

Next, a photoresist mask pattern is formed on the p-type contact layer 6. Then, the p-type contact layer 6, p-type cladding layer 5, light emitting layer 4 and n-type cladding layer 3 are partially etched by inductively coupled plasma using chlorine (Cl₂) gas as an etchant. As a result, the n-type contact layer 2 is partially exposed as shown in FIG. 2B.

Then, as shown in FIG. 2C, a 150 nm thick metal optical reflection film 7 made of Ag, a 100 nm thick metal anti-diffusion film 8 made of W and a 150 nm thick metal cover film 9 made of Au are formed in this order on the p-type contact layer 6 by electron beam deposition and lift-off to provide a p-type electrode 12. Then, heat treatment is carried out under nitrogen flow at 600° C. for 30 minutes to reduce the contact resistance of the p-type electrode 12.

Subsequently, as shown in FIG. 2D, a 5 nm thick Ti layer, a 40 nm thick Al layer, a 40 nm thick Ni layer and a 200 nm thick Au layer are formed in this order on the exposed part of the n-type contact layer 2 by electron beam deposition and lift-off to provide an n-type electrode 13. Then, heat treatment is carried out at 600° C. for about 5 minutes to reduce the contact resistance of the n-type electrode 13.

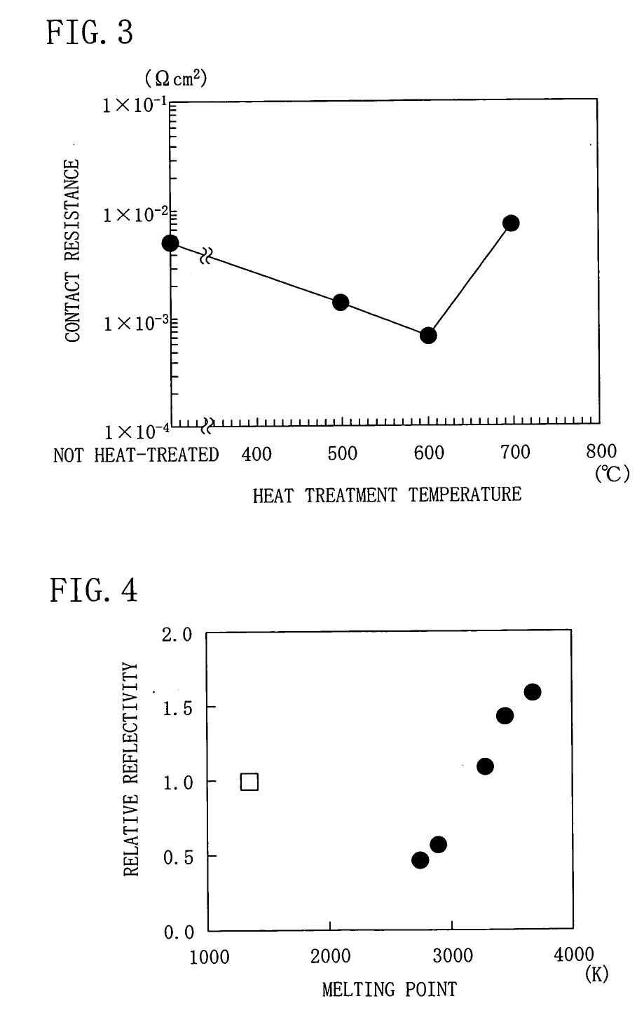

Now, an explanation of a relationship between temperature for heat-treating the p-type electrode 12 and the contact resistance thereof will be provided. FIG. 3 is a graph illustrating a relationship between temperature for heat-treating an Ag electrode formed on a p-type GaN layer and the contact resistance thereof. In FIG. 3, the lateral axis indicates the heat treatment temperature (° C.) and the vertical axis indicates the contact resistance (Ωcm²). The heat treatment is carried out for 30 minutes.

As shown in FIG. 3, the contact resistance between the GaN layer and the electrode decreases as the heat treatment temperature rises. When the heat treatment temperature exceeds 600° C., the contact resistance begins to increase. At the heat treatment temperature of 700° C., the contact resistance becomes higher than that when the heat treatment is not carried out. Therefore, when the Ag electrode is formed on the GaN layer, it is preferable to carry out the heat treatment at 600° C. or lower so as not to increase the contact resistance. It is more preferable to carry out the heat treatment at 500° C. or higher at which the contact resistance is reduced to a sufficient degree. The same is also applied to the case where Al is used as the electrode.

The same tendency is shown in a GaAs- or InP-based light emitting element. In such a case, the contact resistance is minimized when the heat treatment is carried out at a temperature ranging from about 300° C. to about 500° C.

Next, an explanation of a decrease in reflectivity of the p-type electrode 12 caused by the heat treatment will be provided. FIG. 4 shows a graph illustrating a relationship between the kind of metal anti-diffusion films used and reflectivity established when a 150 nm thick Ag film, a 100 nm thick metal anti-diffusion film and a 150 nm thick Au film are stacked in this order on a sapphire substrate while the material for the metal anti-diffusion film is varied and heat treatment is carried out at 600° C. for 30 minutes. In FIG. 4, the lateral axis indicates the melting point (K) of the metal anti-diffusion film and the vertical axis indicates relative reflectivity based on the assumption that the reflectivity obtained when the metal anti-diffusion film is not formed is regarded as 1. The wavelength for measurement is 400 nm and the reflectivity is measured by introducing light from the sapphire substrate side.

As shown in FIG. 4, the reflectivity increases as the melting point of the metal anti-diffusion film rises. When nickel (Ni: melting point is 1730 K) or platinum (Pt: melting point is 2040 K) having a low melting point is used as the material for the metal anti-diffusion film, the reflectivity decreases as compared with the reflectivity obtained when the metal anti-diffusion film is not formed. When tantalum (Ta: melting point is 3290 K), rhenium (Re: melting point is 3450 K) or tungsten (W: melting point is 3690 K) having a high melting point is used, the reflectivity improves as compared with the reflectivity obtained when the metal anti-diffusion film is not formed.

In order to confirm the results to a further extent, analysis has been made on how the interdiffusion between Au and Ag is caused by the heat treatment.

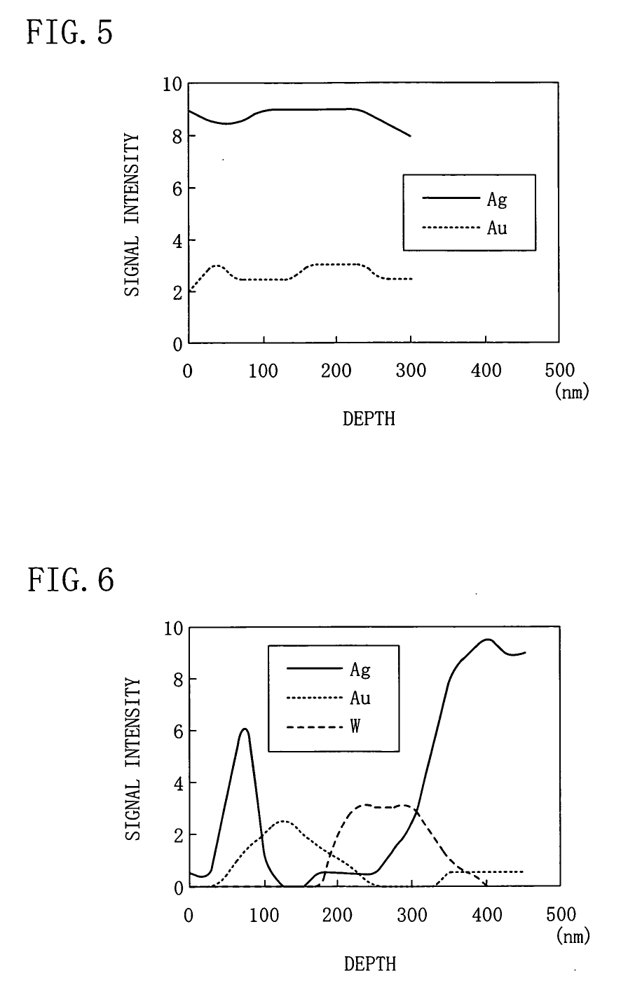

FIG. 5 shows composition distribution in a film stack including a 150 nm thick Ag film and a 150 nm thick Au film formed in this order on a sapphire substrate. The composition distribution is measured in the depth direction by Auger electron spectroscopy (AES) after the film stack is heat-treated at 600° C. for 30 minutes. In FIG. 5, the lateral axis indicates the depth of the film stack from the surface and the vertical axis indicates signal intensity.

As shown in FIG. 5, the signal intensities of Au and Ag are almost the same over the whole region of the film stack from the surface to the bottom. This means that Au and Ag are uniformly distributed from the surface to the bottom of the film stack. Thus, it is apparent that Au and Ag are completely mixed with each other by interdiffusion.

FIG. 6 shows composition distribution in a film stack including a 100 nm thick W film as the metal anti-diffusion film between the Ag film and the Au film measured in the depth direction. As shown in FIG. 6, Au is hardly observed in the bottom part of the film stack. Thus, it is apparent that the interdiffusion between Au and Ag is prevented by providing the metal anti-diffusion film made of W.

Further, as shown in FIG. 6, W is diffused into the Ag film by about 80 nm. Therefore, the metal anti-diffusion film will not affect the metal optical reflection film as long as the thickness of the metal optical reflection film is 80 nm or more. Au is diffused into the W film by about 50 nm. Therefore, the metal anti-diffusion film preferably has a thickness of 50 nm or more.

In the above explanation, the W film is used as the metal anti-diffusion film. However, almost the same results are obtained when Ta or Re is used or when any two or all of W, Ta and Re are used in combination. A metal optical reflection film made of Al also yields the same results.

Referring to FIG. 6, it is observed that Ag is deposited on the surface of the film stack. Although the cause is not clear, the deposition of Ag will not have any harmful influence on the effects of the present invention, i.e., the prevention of diffusion of Au into the Ag film and the prevention of a decrease in reflectivity. Further, bonding is carried out on the metal cover film without causing any harmful influence.

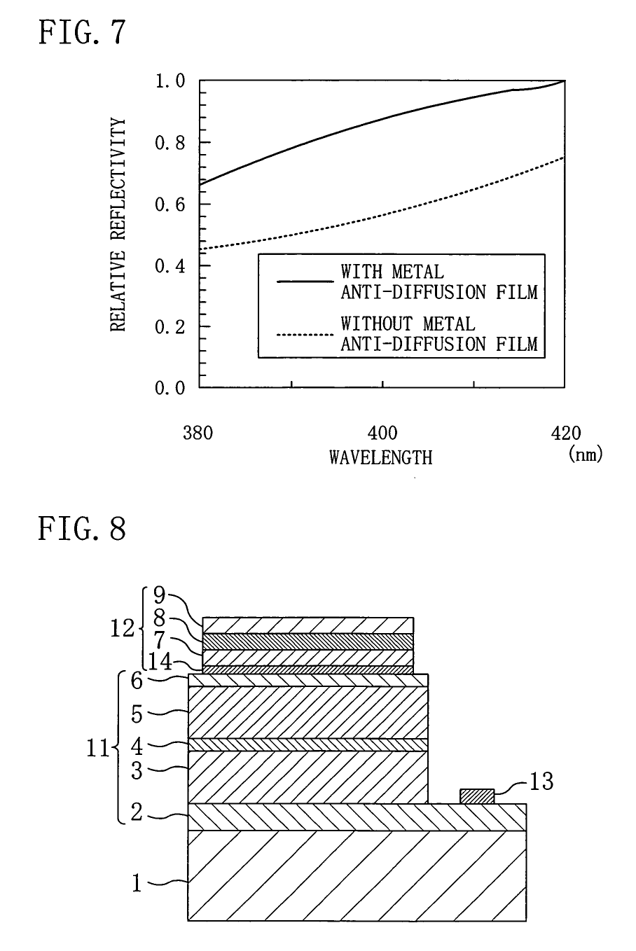

FIG. 7 shows a relationship between light wavelength and reflectivity established in the presence or absence of the metal anti-diffusion film. Referring to FIG. 7, the Ag film and the Au film are 150 nm thick, respectively, and the metal anti-diffusion film is made of W and 100 nm thick. The reflectivity is measured by introducing light from the sapphire substrate side. The lateral axis indicates the wavelength for measurement and the vertical axis indicates relative reflectivity based on the assumption that the reflectivity measured at 420 nm in the presence of the metal anti-diffusion film is regarded as 1.

FIG. 7 clearly shows that the reflectivity improves at any wavelength by providing the metal anti-diffusion film.

As described above, the light emitting element of the present embodiment makes it possible to prevent the interdiffusion between the metal optical reflection film and the metal cover film, thereby improving the reflectivity of the metal optical reflection film. Therefore, the light emitting element is provided with high luminance and high utilization ratio of the emitted light.

The metal cover film may be made of Au, Pt or an alloy containing them in the same manner as the generally used bonding pads.

### VARIANT OF FIRST EMBODIMENT

Hereinafter, an explanation of a light emitting element as a variant of the first embodiment will be provided with reference to the drawings. FIG. 8 is a sectional view illustrating the structure of the variant light emitting element. In FIG. 8, the same components as those shown in FIG. 1 are indicated by the same reference numerals to omit the explanation.

As shown in FIG. 8, the variant light emitting element includes a 2 nm thick metal contact resistance reducing film 14 which is made of Ni and formed between the p-type contact layer 6 and the metal optical reflection film 7. Therefore, the contact resistance between the p-type contact layer 6 and the p-type electrode 12 is reduced and heat generation in the light emitting element is also reduced.

The metal contact resistance reducing film 14 may be made of any metal which is capable of forming good contact with a semiconductor layer such as nickel (Ni), platinum (Pt), titanium (Ti), gold (Au), palladium (Pd) or rhodium (Rh). An alloy or a stack of these metals may also be used.

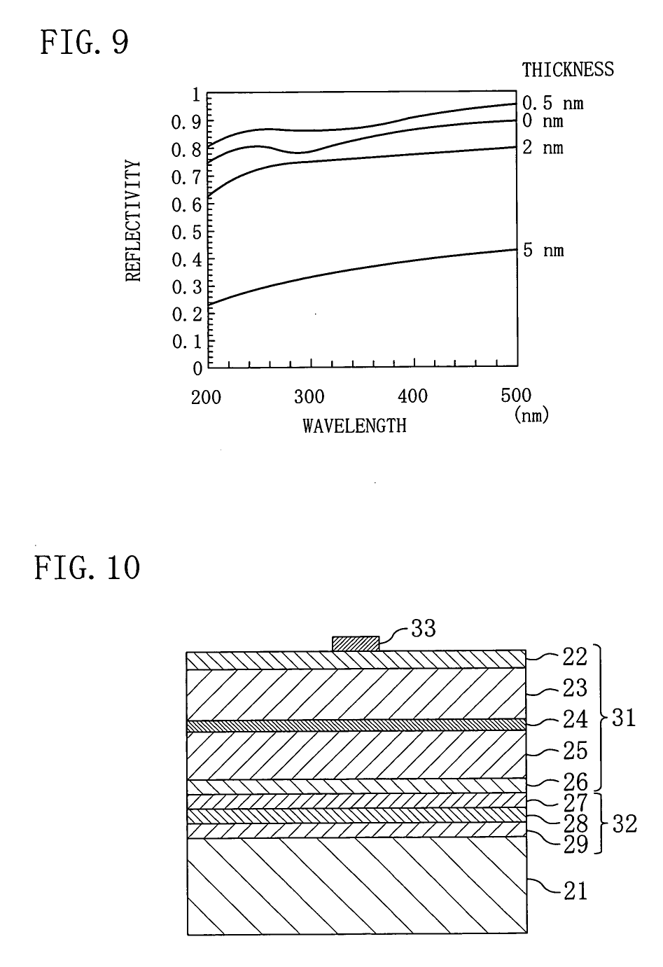

FIG. 9 shows the reflectivity measured after heat treatment has been performed under nitrogen flow at 600° C. for 30 minutes on a film stack including a metal contact resistance reducing film of a certain thickness, a metal optical reflection film, a metal anti-diffusion film and a metal cover film which are formed in this order on a sapphire substrate. In FIG. 9, the lateral axis indicates the wavelength for the measurement and the vertical axis indicates the reflectivity of the p-type electrode provided on the metal contact resistance reducing film. The measurement is carried out by introducing light from the sapphire substrate side. As the metal optical reflection film, metal anti-diffusion film and metal cover film, a 150 nm thick Ag film, a 100 nm thick W film and a 150 nm thick Au film are used, respectively.

As shown in FIG. 9, the reflectivity decreases as the thickness of the metal contact resistance reducing film increases at every measurement wavelength. In particular, the reflectivity decreases rapidly when the thickness of the metal contact resistance reducing film exceeds 2 nm. With the metal contact resistance reducing film of 5 nm thick, the reflectivity drops to about 50% of the reflectivity obtained in the absence of the metal contact resistance reducing film. This indicates that the thickness of the metal contact resistance reducing film is too large to hinder the function of the metal optical reflection film.

When the thickness of the metal contact resistance reducing film is 2 nm or less, the decrease in reflectivity due to the provision of the metal contact resistance reducing film is hardly observed. Further, when the metal contact resistance reducing film is as very thin as 0.5 nm, the reflectivity slightly increases as compared with the reflectivity obtained in the absence of the metal contact resistance reducing film. Although the cause is unclear, it is assumed that the insertion of Ni improves the adhesion between p-type GaN and Ag, thereby reducing the roughness of the interface between the p-type contact layer and the Ag film caused by the heat treatment.

The thickness of the metal contact resistance reducing film may be selected depending on the metal material used for the metal contact resistance reducing film so as not to cause a significant decrease in reflectivity.

### Second Embodiment

An explanation of a light emitting element according to a second embodiment of the present invention and a method for manufacturing the same will be provided with reference to the drawings. FIG. 10 is a sectional view illustrating the structure of the light emitting element according to the second embodiment. As shown in FIG. 10, the light emitting element of the present embodiment is a blue light emitting element using a gallium nitride (GaN)-based material.

On a conductive substrate 21 made of p-type silicon (Si), a 150 nm thick metal cover film 29 made of Au, a 100 nm thick metal anti-diffusion film 28 made of W and a 150 nm thick metal optical reflection film 27 made of Ag are formed in this order to provide a p-type electrode 32.

On the p-type electrode 32, a p-type contact layer 26 made of p-type GaN, a p-type cladding layer 25 made of p-type aluminum gallium nitride (Al_{0.1}Gao_{0.9}N), a light emitting layer 24, an n-type cladding layer 23 made of n-type Al_{0.1}Ga_{0.9}N and an n-type contact layer 22 made of n-type GaN are formed in this order to provide a semiconductor layer stack 31. The light emitting layer 24 is made of InGaN layers and GaN layers which are stacked alternately to have a multiple quantum-well structure.

On the n-type contact layer 22, a 5 nm thick Ti layer, a 40 nm thick Al layer, a 40 nm thick Ni layer and a 20 nm thick Au layer are formed in this order to provide an n-type electrode 33.

In the light emitting element of the second embodiment, light emitted by the light emitting layer 24 is taken out of the top side of the element. Part of the light emitted from the light emitting layer 24 toward the p-type electrode 32 is reflected on the metal optical reflection film 27 toward the top side of the element. Therefore, the emitted light is efficiently used.

Hereinafter, an explanation of a method for manufacturing the light emitting element of the second embodiment will be provided with reference to the drawings.

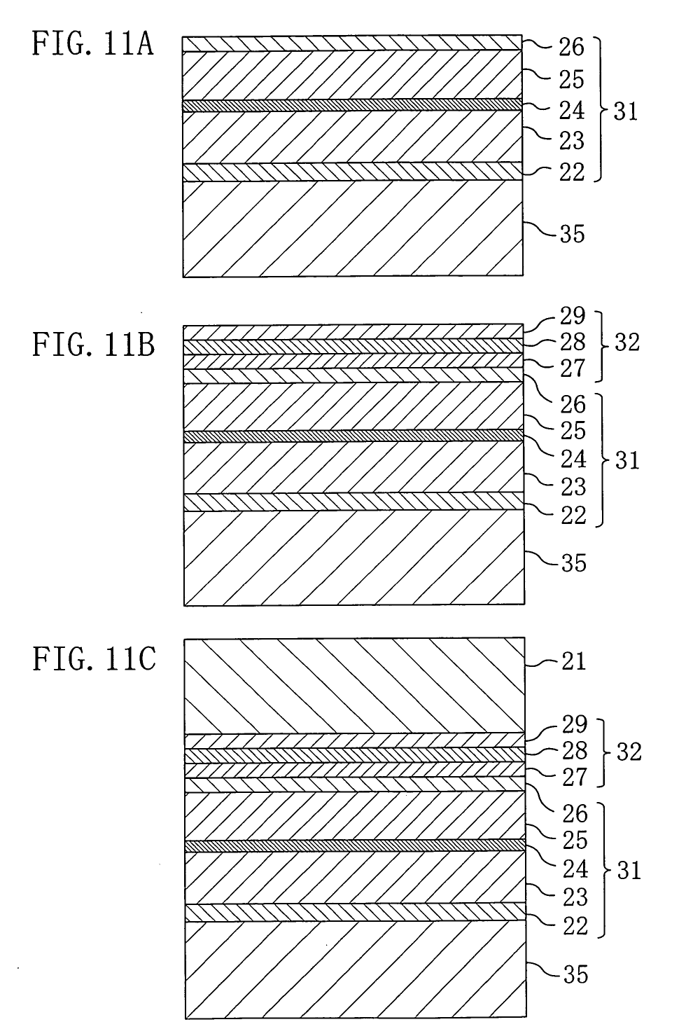

FIGS. 11A to 11C are sectional views illustrating the steps of manufacturing the light emitting element of the present embodiment. As shown in FIG. 11A, an n-type contact layer 22, an n-type cladding layer 23, a light emitting layer 24, a p-type cladding layer 25 and a p-type contact layer 26 are grown in this order on a sapphire substrate 35 by metal-organic chemical vapor deposition (MOCVD) to provide a semiconductor layer stack 31.

Then, as shown in FIG. 11B, a 150 nm thick metal optical reflection film 27 made of Ag, a 100 nm thick metal anti-diffusion film 28 made of W and a 150 nm thick metal cover film 29 made of Au are formed in this order on the p-type contact layer 26 by electron beam deposition to provide a p-type electrode 32. Then, heat treatment is carried out under nitrogen flow at 600° C. for 30 minutes to reduce the contact resistance of the p-type electrode 32.

Then, as shown in FIG. 11C, a substrate 21 made of Si is bonded to the metal cover film 29. The bonding is carried out by a known method. For example, the substrate 21 and the metal cover film 29 may be press-bonded by performing heat treatment at 300° C. for 10 minutes under pressure. Or alternatively, a tin layer is formed in advance on the substrate 21 to cause eutectic bonding between gold and tin.

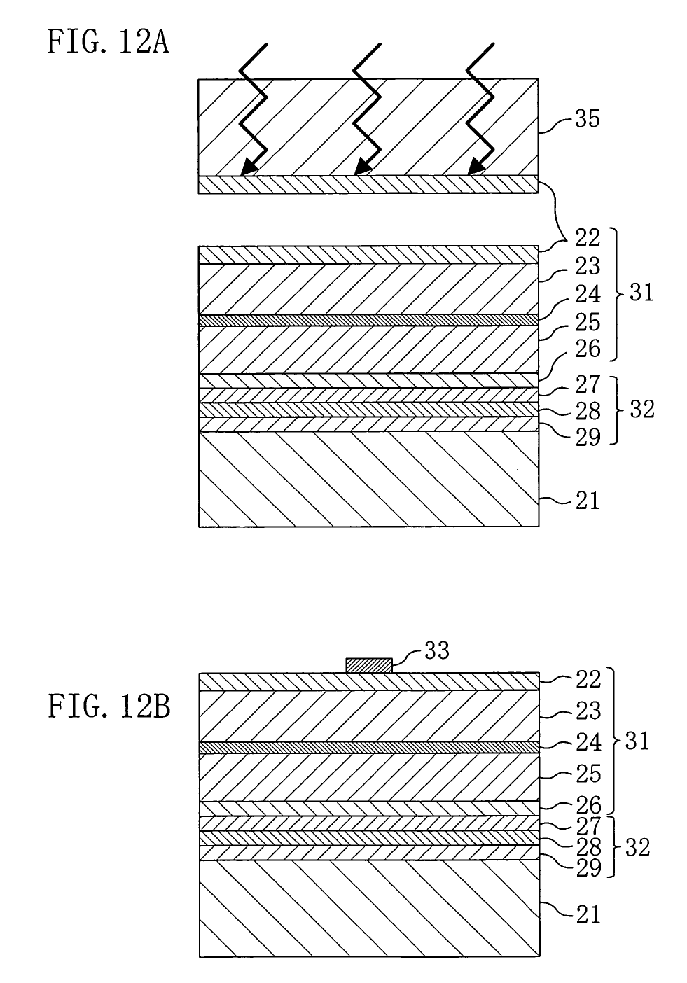

Then, as shown in FIG. 12A, high-power yttrium aluminum garnet (YAG) laser light is applied to the n-type contact layer 22 through the sapphire substrate 35 at a wavelength of 355 nm to dissolve part of the n-type contact layer 22, thereby removing the sapphire substrate 35.

Subsequently, as shown in FIG. 12B, a 5 nm thick Ti layer, a 40 nm thick Al layer, a 40 nm thick Ni layer and a 200 nm thick Au layer are formed in this order on part of the exposed n-type contact layer 22 by electron beam deposition and lift-off to provide an n-type electrode 33. Then, heat treatment is carried out at 600° C. for about 5 minutes to reduce the contact resistance of the n-type electrode 33.

In the thus obtained light emitting element, the interdiffusion between the metal cover film 29 and the metal optical reflection film 27 is prevented. Therefore, the reflectivity of the metal optical reflection film 27 is kept high, thereby providing the light emitting element with high luminance.

In the light emitting element of the present embodiment, a metal contact resistance reducing film may be provided between the p-type contact layer 26 and the metal optical reflection film 27 in the same manner as in the variant of the first embodiment.

In the first and second embodiments, an Ag film is used as the metal optical reflection film. However, other metal may be used as long as it has high optical reflectivity. For example, an Al film or a layered film of Ag and Al may be used as the metal optical reflection film.

The sapphire substrate used for forming the semiconductor layer stack may be replaced with a substrate made of GaN, AlGaN, SiC, ZnO, Si, GaAs, InP, LiGaO₂, LiAlO₂ or a mixed crystal of them. Further, instead of a group III-V nitride semiconductor used for the semiconductor layer stack, GaAs-, InP- or GaP-based semiconductor or a II-VI group compound semiconductor may also be used.

Thus, as described above, the light emitting element and the method for manufacturing the same according to the present invention are effective in that the light emitting element is provided with high luminance, low contact resistance and high reflectivity. The present invention is useful as a light emitting element which works with high luminance and high efficiency and a method for manufacturing the same.

What is claimed is:

1. A light emitting element comprising:
a semiconductor layer stack including a light emitting layer;
a metal optical reflection film which is formed on the surface of the semiconductor layer stack opposite to the surface from which light emitted from the light emitting layer is taken out of the semiconductor layer stack to reflect the emitted light;
a metal cover film which is formed above the metal optical reflection film to prevent the metal optical reflection film from coming off; and
a metal anti-diffusion film which is formed between the metal optical reflection film and the metal cover film to prevent interdiffusion between the metal optical reflection film and the metal cover film, wherein
metal anti-diffusion film is a single layer film made of any one of tungsten, rhenium and tantalum or a layered film made of two or more of tungsten, rhenium and tantalum.

2. The light emitting element according to claim 1, wherein
the thickness of the metal anti-diffusion film is 50 nm or more.

3. The light emitting element according to claim 1, wherein
the metal optical reflection film is a single layer film made of aluminum or silver or a layered film made of aluminum and silver.

4. The light emitting element according to claim 3, wherein
the thickness of the metal optical reflection film is 80 nm or more.

5. The light emitting element according to claim 1, wherein
the metal cover film is made of gold, platinum or an alloy containing at least one of gold and platinum.

6. The light emitting element according to claim 1 further comprising
a metal contact resistance reducing film which is formed between the metal optical reflection film and the semiconductor layer stack to reduce contact resistance between the metal optical reflection film and the semiconductor layer stack.

7. The light emitting element according to claim 6, wherein
the metal contact resistance reducing film is a single layer film made of any one of nickel, titanium, gold, platinum, palladium and rhodium or a layered film made of two or more of nickel, titanium, gold, platinum, palladium and rhodium.

8. The light emitting element according to claim 1, wherein
the semiconductor layer stack is made of a group III nitride semiconductor.

9. A method for manufacturing a light emitting element comprising the steps of:
forming a first conductivity type semiconductor layer, a light emitting layer and a second conductivity type semiconductor layer in this order on a first substrate to provide a semiconductor layer stack;
forming a metal optical reflection film for reflecting light emitted from the light emitting layer, a metal anti-diffusion film which is a single layer film made of any one of tantalum, rhenium and tungsten or a layered film made of two or more of tantalum, rhenium and tungsten and a metal cover film for preventing the metal optical reflection film from coming off in this order on the second conductivity type semiconductor layer to provide an electrode; and
heat-treating the electrode.

10. The method according to claim 9, wherein
the thickness of the metal anti-diffusion film is 50 nm or more.

11. The method according to claim 9, wherein
the semiconductor layer stack is made of a group III nitride semiconductor and
the heat treatment is carried out at a temperature ranging from 500° C. or higher to 600° C. or lower.

12. The method according to claim 9, wherein
the metal optical reflection film is a single layer film made of aluminum or silver or a layered film made of aluminum and silver.

13. The method according to claim 12, wherein
the thickness of the metal optical reflection film is 80 nm or more.

14. The method according to claim 9, wherein
the metal cover film is made of gold, platinum or an alloy containing at least one of gold and platinum.

15. The method according to claim 9 further comprising the step of:
forming a metal contact resistance reducing film between the metal optical reflection film and the second conductivity type semiconductor layer to reduce contact resistance between the metal optical reflection film and the second conductivity type semiconductor layer.

16. The method according to claim 15, wherein
the metal contact resistance reducing film is a single layer film made of any one of nickel, titanium, gold, platinum, palladium and rhodium or a layered film made of two or more of nickel, titanium, gold, platinum, palladium and rhodium.

17. The method according to claim 9 further comprising the steps of:
bonding a second conductive substrate to the metal cover film; and
peeling the first substrate off before the step of bonding the second conductive substrate to the metal cover film.
